(19) United States
(12) Patent Application Publication
(10) Pub. No.: US 2026/0185635 A1
(43) Pub. Date: Jul. 2, 2026

(54) FLEXIBLE AND DURABLE HOLDING APPARATUS FOR SECURING ELONGATED ARTICLES WITH CENTRAL OR OFF-CENTERED ANCHORING, ADJUSTABLE STRAP SYSTEM AND LOCKING FEATURES

(71) Applicant: Eldho KURIAKOSE, Kerala (IN)

(72) Inventor: Eldho KURIAKOSE, Kerala (IN)

(21) Appl. No.: 19/398,987

(22) Filed: Nov. 24, 2025

(30) Foreign Application Priority Data
Dec. 26, 2024 (IN) 202441103089

(51) Int. Cl. F16L 3/01; H02G 3/32

(52) U.S. Cl. CPC F16L 3/01; H02G 3/32

(57) ABSTRACT

The device is constructed from a durable and flexible material, such as high-density polyethylene (HDPE), thermoplastic elastomer (TPE) or reinforced silicone or any metals. These materials ensure high tensile strength, elasticity and resistance to environmental factors like UV radiation, moisture and temperature variations, making the device suitable for diverse applications in both indoor and outdoor settings. These material properties ensure the device's long-term durability, even challenging conditions and the flexibility of the material allows the device to conform to pipes and wires of varying diameters, providing a secure grip without causing abrasion or structural damage to the articles.

The construction of the device features a central or off-centered anchoring section designed to be affixed to a wall using a screw or similar fastener. This central or off-centered region is reinforced to withstand the mechanical stresses associated with the weight of the secured articles. The central or off-centered attachment point includes a pre-formed hole or recess for standard screws or wall plugs, ensuring a stable connection. Extending symmetrically or asymmetrically from the central or off-centered point are elongated flexible strips crafted from the same flexible material. These strips are designed to be wound around the articles to be secured and are equipped with an integrated locking mechanism, such as a snap-fit buckle, loop-and-hook fasteners or ratcheting clasps at their ends ensuring adjustable and secure fastening. This allows for adjustable tightness based on the article's dimensions, providing a secure and reliable hold. The device is installed by first securing the central or off-centered attachment point to the wall using screws. The pipe or wire is then positioned along the wall, the flexible strips are wrapped around the article and the locking mechanism is engaged. This ensures that the strips remain tensioned, providing a secure and organized arrangement of pipes and wires.

### CROSS REFERENCE TO RELATED APPLICATIONS

Applicant claims priority and the benefit of Indian Patent application 202441103089, filed 26 Dec. 2024(26 -12-2024), said application being hereby incorporated herein in its entirety by reference.

### TECHNICAL FILED

The present invention is generally directed to the field of structural support devices and more specifically to a flexible and adaptable fastening device designed to hold articles securely in place by focusing on the development of a versatile and reliable mounting solution⋅ that utilizes advanced materials and innovative design features to ensure secure attachment and organization of various types of elongated objects. The device is constructed from flexible, high-strength materials and incorporates an innovative locking mechanism, ensuring secure attachment and reliable performance in various environmental conditions.

### BACKGROUND OF THE INVENTION

The management and organization of elongated articles such as pipes, wires, and cables along wall surfaces are critical in various settings, including residential, commercial and industrial environments. Proper securing of these elements ensures safety, functionality and aesthetic appeal. Traditional methods often involve rigid clamps, brackets or conduits that may lack adaptability to different sizes and shapes of the articles, potentially leading to inefficient installations and increased labor costs. Traditional methods of securing pipes and wires often involve rigid structures that can cause damage or are difficult to install. As technology and infrastructure evolve, the demand for organized and safe installations of electrical wiring, plumbing pipes and network cables has become increasingly important and the traditional methods of securing these articles often lead to cluttered spaces, potential hazards, multiple damages to the walls and difficulties in maintenance. An analysis of various prior art documents is summarized below:
U.S. Pat. No. 9,651,174: Wall Mounted Receiver. This patent describes a wall-mounted receiver designed to accommodate insulated or non-insulated pipes with flexible inlet capabilities, primarily used in refrigeration or air conditioning equipment.
U.S. Pat. No. 6,467,734: Bracket for Securing Pipes. This patent discloses a bracket that supports tubing at bends, featuring an open side for insertion and projecting lips to prevent the tubing from sliding⋅ out, ensuring secure placement.
U.S. Pat. No. 7,621,487: Twist-Lock Base for Pipe Holders. This patent presents a support for conduits held on a channel member with a C-shaped cross-section, utilizing a twist-lock mechanism to secure pipes in place.
U.S. Pat. No. 5,328,139A: Wall Article Hanging Device. This patent describes a wall article hanging device with a metal plate and prongs for angled penetration into a wall surface, providing a stationary, level and flush mount. It highlights the importance of secure attachment and stability, similar to the central or off-centered anchoring section of the present invention.
EP0728975B1: Device for Holding Elongated Articles. This European patent covers a device for holding elongated. articles such as cables or hoses on walls or ceilings. It features loops for threading cables and an extension for added support, paralleling the flexible strips and locking mechanisms of the present invention.
W02014032921A1: Device for Working Elongated Articles. This international patent application discusses a device for working elongated articles in the transverse direction, emphasizing the importance of flexibility and adaptability in handling various shapes and sizes of articles.

The non-patent literature includes “Automatic Verticality Monitoring and Securing System for Large Circular Steel Pipes” Published in Electronics (2023), this ⋅article proposes an automatic verticality securing system for large circular steel pipes based on a verticality⋅ monitoring system, emphasizing the importance of secure pipe installation in construction.

Journal of Materials Chemistry discloses the article “Flexible Electrode Materials for Emerging Electronics.” This article explores flexible electrode materials for emerging electronics, discussing the development of flexible substrates and active materials. It provides insights into the use of flexible materials, which are relevant to the construction of the present invention.

But none of the prior art documents disclose the device of the present invention and the flexibility offered by the present invention in ease of securing flexible objects to vertical walls.

### OBJECTS OF INVENTION

It is a primary objective of the present invention to provide a reliable device that securely holds elongated articles such as pipes and wires along walls, ensuring stability and preventing movement or damage.

It is a secondary objective of the present invention to utilize flexible and durable materials like high-density polyethylene (HDPE), thermoplastic elastomer (TPE), and reinforced silicone or any metals to construct the device, offering high tensile strength, elasticity, and resistance to environmental factors.

It is a tertiary objective of the present invention to ensure long-term durability and functionality of the device in indoor and outdoor environments, withstanding UV radiation, moisture and temperature variations.

It is a fourth objective of the present invention to design the device with a central or off-centered anchoring section featuring pre-formed holes for standard screws, facilitating easy and secure attachment to various wall surfaces. and that is robust and reinforced, capable of withstanding mechanical stresses associated with the weight of pipes or wires, ensuring secure attachment to the wall.

It is a fifth objective of the present invention to incorporate a pre-formed hole or recess⋅ in the central or off-centered attachment point, dimensioned to accommodate standard screws or wall plugs for firm and stable wall connection.

It is a sixth objective of the present invention to engineer elongated strips extending from the central or off-centered attachment point, made of flexible material, capable of conforming to pipes and wires of varying diameters without causing damage.

It is a seventh objective of the present invention to incorporate an integrated locking mechanism at the ends of the elongated strips such as snap-fit buckles, loop-and-hook fasteners or ratcheting clasps at the ends of the strips that allows users to adjust the tightness of the hold based on the specific dimensions of the pipes or wires being secured.

It is an eighth objective of the present invention to create a device that can accommodate a wide range of pipe and wire diameters, making it suitable for various applications in residential, commercial, and industrial settings and facilitate easy installation and use, enabling quick adaptation to irregularly shaped articles or bundles of wires, and eliminating the need for custom holders.

It is a ninth objective of the present invention to offer a modular design that allows the device to be spaced along the length of the wall at intervals, providing uniform support for longer pipes or wires, minimizing sagging or misalignment and to ensure that the device is lightweight yet durable, minimizing the overall load on mounting surfaces while simplifying handling and installation.

It is a tenth objective of the present invention to allow for modular spacing of multiple devices along a wall, providing uniform support for longer pipes or wires while minimizing sagging or misalignment and to ensure that the flexible strips conform to the shape of the secured articles without causing abrasion or structural damage, maintaining the integrity of the pipes or wires.

It is an eleventh objective of the present invention to contribute to a neat and organized appearance in installations by providing a streamlined method for managing pipes and wires along walls and to enable quick adaptation to irregularly shaped articles or bundles of wires, eliminating the need for custom holders and enhancing usability across different scenarios.

It is a final objective of the present invention to provide an aesthetically pleasing and organized arrangement of pipes and wires, enhancing the overall appearance and functionality of residential wiring systems, industrial piping and network cable management.

### SUMMARY OF THE INVENTION

The invention relates to a device for securing and organizing elongated articles, such as pipes and wires, along wall surfaces exhibits a technically advanced yet simple structure, ensuring versatility and reliability in its application.

The device is constructed from a durable and flexible material, such as high-density polyethylene (HDPE), thermoplastic elastomer (TPE) or reinforced silicone or any metals. These materials ensure high tensile strength, elasticity and resistance to environmental factors like UV radiation, moisture and temperature variations, making the device suitable for diverse applications in both indoor and outdoor settings. These material properties ensure the device's long-term durability, even in challenging conditions and the flexibility of the material allows the device to conform to pipes and wires of varying diameters, providing a secure grip without causing abrasion or structural damage to the articles.

The construction of the device features a central or off-centered anchoring section designed to be affixed to a wall using a screw or similar fastener. This central or off-centered region is reinforced to withstand the mechanical stresses associated with the weight of the secured articles. The central or off-centered attachment point includes a pre-formed hole or recess for standard screws or wall plugs, ensuring a stable connection. Extending symmetrically or asymmetrically from the central or off-centered point are elongated flexible strips crafted from the same flexible material. These strips are designed to be wound around the articles to be secured and are equipped with an integrated locking mechanism, such as a snap-fit buckle, loop-and-hook fasteners or ratcheting clasps at their ends ensuring adjustable and secure fastening. This allows for adjustable tightness based on the article's dimensions, providing a secure and reliable hold. The device is installed by first securing the central or off-centered attachment point to the wall using screws. The pipe or wire is then positioned along the wall, the flexible strips are wrapped around the article and the locking mechanism is engaged. This ensures that the strips remain tensioned, providing a secure and organized arrangement of pipes and wires.

Its lightweight yet durable construction facilitates easy installation and minimizes the load on the mounting surface. The flexibility of the strips enables quick and adaptable application to irregularly shaped articles or bundles of wires, eliminating the need for custom holders. The modular nature of the device allows for spacing along the wall, ensuring uniform support for longer articles while minimizing sagging or misalignment. This design provides a versatile, efficient and secure solution for organizing elongated articles of varying diameters, ensuring long-term reliability and ease of use.

A device for holding and securing an elongated article along a wall, comprising:
A central or off-centered anchoring section providing high tensile strength and resistance to environmental factors and made of a flexible material, designed for wall attachment, featuring a pre-formed hole or recess for accommodating standard screws or wall plugs;
Reinforcement around the said central or off-centered anchoring section to withstand mechanical stresses and sustain axial loads without deformation;
Elongated strips extending symmetrically or asymmetrically on both sides from the central or off-centered anchoring section, made of the same flexible material, designed to wrap around the elongated articles;
An integrated locking mechanism at the ends of the elongated strips, configured to secure the elongated strips in place, thereby holding the long articles firmly against the wall, allowing for adjustable tightness based on the dimensions of the articles being secured wherein the locking mechanism being selected from the group consisting of snap-fit buckles, loop-and-hook fasteners or ratcheting clasps wherein the flexible material being selected from the group consisting of high-density polyethylene (HDPE), thermoplastic elastomer (TPE) or reinforced silicone or any metals.

A method for securing elongated articles along a wall using a device with a central or off-centered anchoring section, elongated flexible strips, and a locking mechanism, the method comprising:
Securely mounting the central or off-centered anchoring section to a wall using screws or wall plugs;
Positioning the elongated article adjacent to the wall and aligning it with the central or off-centered anchoring section;
Wrapping the elongated flexible strips around the elongated article each extending from said central or off-centered anchoring section, around said elongated article;
Engaging the integrated locking mechanisms to ensure the strips remain tensioned, holding the articles firmly against the wall.

### BRIEF DESCRIPTION OF THE DRAWINGS

FIG. 1 illustrates the pictorial representation of the device for holding and securing an elongated article along a wall.

### DETAILED DESCRIPTION OF THE INVENTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will. recognize applications of these concepts not particularly addressed herein. It should be understood that these concepts and applications fall within the scope of the disclosure and the accompanying claims.

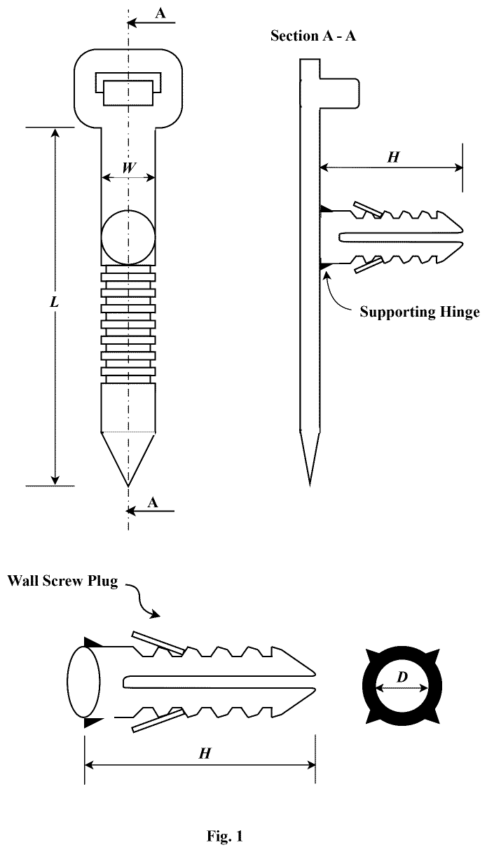

The present invention as illustrated in FIG. 1 relates to a versatile and efficient device designed for securing elongated articles, such as pipes, wires and cables, along wall surfaces. This innovation addresses challenges associated with organizing and fastening such articles in residential, commercial and industrial settings. By integrating advanced materials and a simple yet effective locking mechanism, the device offers adaptability, durability and ease of use. The device is designed for holding elongated articles such as pipes and wires along a wall represents a significant advancement in cable management and structural support technology.

The device features a technically advanced yet simple structure that ensures effective support for elongated articles. It is constructed primarily from flexible materials such as high-density polyethylene (HDPE), thermoplastic elastomer (TPE), or reinforced silicone or any metals. These materials are selected for their high tensile strength, elasticity and resistance to environmental factors like UV radiation, moisture and temperature variations. Such properties ensure the devices long-term durability, making it suitable for both indoor and outdoor use.

At its core, the device features a central or off-centered anchoring section that serves as the main attachment point to the wall. The central or off-centered anchoring section is a crucial component of the device, providing the primary interface for attaching the device to a wall surface and ensuring the secure support of elongated articles like pipes and wires. The central or off-centered anchoring section is constructed from high-quality, flexible materials such as high-density polyethylene (HDPE), thermoplastic elastomer (TPE) or reinforced silicone or any metals. These materials are chosen for their high tensile strength and. durability, ensuring the anchoring section can withstand significant mechanical stresses.

To enhance its load-bearing capacity, the central or off-centered anchoring section is reinforced. This reinforcement is designed to prevent deformation or failure under axial loads, ensuring stability and longevity. The reinforced structure ensures that the device can support the weight of the pipes or wires securely. At the core of the central or off-centered anchoring section is a pre-formed hole or recess. This hole is precisely dimensioned to accommodate standard screws or wall plugs, enabling a firm and stable connection to the wall. The use of screws ensures that the device remains securely attached over time, reducing the risk of slippage or detachment.

The central or off-centered anchoring section serves as the main attachment point, distributing the weight of the secured articles evenly across the wall surface. Its robust construction and reinforcement ensure that it can handle the mechanical stresses associated with supporting elongated articles. The central or off-centered anchoring section is first positioned against the wall at the desired location. A screw or wall plug is inserted through the pre-formed hole and fastened securely into the wall. This provides a solid foundation for the device. Once the central or off-centered anchoring section is secured, the elongated articles, such as pipes or wires, are aligned with the device. The flexible strips extending from the central or off-centered anchoring section are wrapped around the articles and locked in place using the integrated locking mechanism.

The reinforced design of the central or off-centered anchoring section ensures that it can sustain significant axial loads without deforming or failing. This stability is critical for maintaining the secure attachment of pipes and wires over time. Constructed from high-strength materials like HDPE, TPE, or reinforced silicone or any metals, the central or off-centered anchoring section is resistant to environmental factors such as UV radiation, moisture and temperature variations. This durability makes the device suitable for both indoor and outdoor applications. The pre-formed hole or recess for accommodating standard screws or wall plugs simplifies the installation process. The device can be quickly and securely mounted to a variety of wall surfaces without the need for specialized tools or techniques.

The central or off-centered anchoring section of the device is a robust and essential component that provides secure attachment and reliable support for elongated articles. Its design, materials durability and ease of installation, making and reinforcement ensure long-term it a versatile and effective solution for organizing and managing pipes, wires and cables along wall surfaces.

Extending symmetrically or asymmetrically from the central or off-centered anchoring section are elongated strips made from the same flexible material. These strips are engineered to be wrapped around the elongated articles that require fastening. The flexibility of the strips allows them to conform to a wide range of shapes and diameters, making the device suitable for pipes, wires or bundled cables. The ends of these strips are equipped with an integrated locking mechanism, which may include snap-fit buckles, loop-and-hook fasteners or ratcheting clasps. These mechanisms provide adjustable and secure fastening, ensuring that the articles remain firmly in place.

The elongated strips are integral to the device's design, providing the flexibility and adaptability needed to secure various elongated articles, such as pipes and wires, effectively and reliably. The elongated strips are constructed from the same high-quality, flexible materials as the central or off-centered anchoring section. This includes options like high-density polyethylene (HDPE), thermoplastic elastomer (TPE) or reinforced silicone or any metals. These ⋅materials are chosen for their durability, elasticity and resistance to environmental factors, ensuring the strips maintain their integrity under various conditions. The present material may be replaced with, any of the metals includes ferrous and non-ferrous etc.

Extending symmetrically or asymmetrically on either sides of the central or off-centered anchoring section, the strips are designed to wrap around the articles being secured. The symmetrical design ensures even distribution of force and stability, preventing any imbalance that could lead to slippage or detachment. The primary function of the elongated strips is to wrap around the elongated articles, such as pipes, wires or cables. Their flexibility allows them to conform to a wide range of shapes arid diameters, providing a secure grip without causing damage to the articles. This adaptability is crucial for accommodating irregularly shaped items or bundles of wires.

At the ends of the elongated strips, an integrated locking mechanism is employed to secure the strips in place once wrapped around the articles. This mechanism can include various designs such as snap-fit buckles, loop-and-hook fasteners or ratcheting clasps. Each of these designs offers adjustability, allowing the user to tighten or loosen the grip based on the specific dimensions of the article. Once engaged, the locking mechanism ensures that the strips remain tensioned, preventing unintentional loosening due to vibrations or external forces.

The operation of the elongated strips is straightforward. After the central or off-centered anchoring section is securely mounted to the wall, the user positions the elongated articles adjacent to the wall. The strips are then wrapped around the articles and the locking mechanism is engaged to secure them. This process can be completed quickly and efficiently, making the device highly user-friendly. The flexible nature of the elongated strips allows them to adapt to various shapes and sizes of articles. This versatility eliminates the need for multiple specialized holders, making the device a one-size-fits-all solution for securing pipes, wires and cables.

The integrated locking mechanisms at the end of the strips provide a secure and adjustable grip on the articles. This prevents the strips from loosening over time, maintaining a stable and reliable hold. The symmetrical extension of the strips ensures even distribution of force, preventing imbalances that could lead to slippage or detachment. This uniform support is particularly important for longer articles, reducing the risk of sagging or misalignment. The elongated strips extending symmetrically or asymmetrically from the central or off-centered anchoring section are a key feature of the device. Their flexible construction, integrated locking mechanisms, and versatile application make them an essential component for securely holding and organizing elongated articles along wall surfaces.

The locking mechanism is a critical component of the device designed for securing elongated articles such as pipes, wires, and cables along wall surfaces. It ensures that the flexible strips, which extend from the central or off-centered anchoring section, remain securely fastened around the articles, providing a stable and reliable hold. This section explains the detailed design, functionality, and advantages of the locking mechanism.

The device incorporates various types of integrated locking mechanisms to accommodate different user preferences and requirements. These mechanisms include:
Snap-Fit Buckles: These buckles are designed to snap into place with a simple push. They consist of interlocking male and female components that create a secure connection when engaged. Snap-fit buckles are known for their ease of use and quick release capabilities.
Loop-and-Hook Fasteners: These fasteners consist of two strips of fabric, one with tiny hooks and the other with looped fibers. When pressed together, the hooks catch the loops, creating a strong, adjustable bond. Loop-and-hook fasteners are highly flexible and can be adjusted to various tightness levels.
Ratcheting Clasps: Ratcheting clasps feature a toothed mechanism that allows the strips to be tightened incrementally. The user pulls the strip through the clasp, and the teeth engage to hold the strip in place. To release the strip, a lever or button is pressed to disengage the teeth. This type of clasp offers precise control over the tightness of the hold.

The locking mechanisms are constructed from durable materials such as reinforced plastics or metals, chosen for their strength and longevity. These materials ensure that the locking mechanisms can withstand repeated use and maintain their functionality over time. One of the primary functions of the locking mechanism is to allow for adjustable fastening. Depending on the type of mechanism, the user can tighten or loosen the grip based on the specific dimensions of the elongated articles being secured. This adjustability is crucial for ensuring a snug and secure fit, regardless of the size or shape of the articles. Once engaged, the locking mechanism provides a reliable grip that prevents the flexible strips from loosening over time. This is particularly important in environments subject to vibrations or external forces, where unintentional loosening could lead to detachment or misalignment of the articles.

The design of the locking mechanisms prioritizes ease of use. Snap-fit buckles, loop-and-hook fasteners and ratcheting clasps are all user-friendly, allowing for quick and efficient installation. The mechanisms are designed to be engaged and disengaged with minimal effort, making the device convenient for both initial installation and subsequent adjustments. It is constructed from high-quality materials, the locking mechanisms are designed to withstand wear and tear. This durability ensures that the device remains functional and reliable over long periods, even with frequent use. The locking mechanisms provide a firm hold, preventing the flexible strips from slipping or becoming loose. This secure fit is essential for maintaining the stability and organization of the elongated articles being secured.

The operation of the device is straightforward, enabling quick and efficient installation. To use the device, the central or off-centered anchoring section is first mounted to the wall using a screw or similar fastening means. Once secured, the elongated article, such as a pipe or cable, is positioned adjacent to the wall and aligned with the central or off-centered anchoring section. The flexible strips are then wrapped around the article and secured using the integrated locking mechanism. This locking system allows the user to adjust the tightness of the hold based on the specific dimensions of the article, ensuring a snug and stable fit. Once locked, the device provides reliable support, even under vibrations or external stresses.

The flexible nature of the materials allows the strips to adapt to irregularly shaped articles or bundles, eliminating the need for custom-made holders. Additionally, the lightweight construction of the device reduces the overall load on the wall surface, making it suitable for a variety of applications without compromising structural integrity.

The wall-mounted device for securing elongated articles represents a significant advancement in the field of fastening and organizing systems. By combining robust materials, a reinforced anchoring section, and an adjustable locking mechanism, the invention delivers a versatile and reliable solution for a wide range of applications. It's simple yet effective design ensures ease of use and broad applicability, making it an indispensable tool for managing pipes, wires, and cables in diverse environments.

A number of implementations have been described. Nevertheless, it will be understood that various modifications can be made without departing from the spirit and scope of the disclosure. Accordingly, other implementations are within the scope of the following claims. Still other implementations are within the following claims.

1. A device for holding and securing an elongated article along a wall, comprising:
a central or off-centered or anchoring section providing high tensile strength and resistance to environmental factors and made of a flexible material, designed for wall attachment, featuring a pre-formed hole or recess for accommodating standard screws or wall plugs;
reinforcement around the said central or off-centered anchoring section to withstand mechanical stresses and sustain axial loads without deformation;
an elongated strips extending symmetrically or asymmetrically on both sides from the central or off-centered anchoring section, made of the same flexible material, designed to wrap around the elongated articles;
an integrated locking mechanism at the ends of the elongated strips, configured to secure the elongated strips in place, thereby holding the long articles firmly against the wall, allowing for adjustable tightness based on the dimensions of the articles being secured wherein the locking mechanism being selected from the group consisting of snap-fit buckles, loop-and-hook fasteners or ratcheting clasps wherein the flexible material being selected from the group consisting of high-density polyethylene (HDPE), thermoplastic elastomer (TPE) or reinforced silicone or any metals.

2. The device of claim 1, wherein the flexible material is resistance to temperature variations, UV radiation and moisture.

3. The device of claim 1, wherein the elongated flexible strips are textured or ribbed to enhance grip on the elongated articles.

4. The device of claim 3, wherein the elongated flexible strips are wrapped in a crisscross pattern around the elongated article to provide enhanced stability.

5. The device of claim 1, wherein the central or off-centered anchoring section includes additional reinforcements to enhance its load-bearing capacity.

6. The device of claim 1, wherein the integrated locking mechanisms are designed to prevent unintentional loosening due to vibrations or external forces.

7. The device of claim 1, wherein multiple devices can be spaced along a wall at intervals to provide uniform support for longer pipes or wires.

8. A method for securing elongated articles along a wall using a device with a central or off-centered anchoring section, elongated flexible strips, and a locking mechanism, the method comprising:
securely mounting the central or off-centered anchoring section to a wall using screws or wall plugs;
positioning the elongated article adjacent to the wall and aligning it with the central or off-centered anchoring section;
wrapping the elongated flexible strips around the elongated article each extending from said central or off-centered anchoring section, around said elongated article;
engaging the integrated locking mechanisms to ensure the strips remain tensioned, holding the articles firmly against the wall.

9. The method of claim 8, further comprising the step of spacing the devices along the length of the wall at intervals to provide uniform support for longer articles and minimize sagging or misalignment.

10. The method of claim 8, further comprising the step of adjusting the tightness of the hold by varying the engagement of the integrated locking mechanisms based on the specific dimensions of the articles being secured.
